(19) United States
(12) Patent Application Publication
(10) Pub. No.: US 2006/0011304 A1
(43) Pub. Date: Jan. 19, 2006

(54) APPARATUS AND METHOD OF ATTACHING OPTICAL FILMS

(76) Inventor: Teng-Yin Nung, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,812

(22) Filed: Oct. 6, 2004

(30) Foreign Application Priority Data
Jul. 15, 2004 (TW) 93121098

(51) Int. Cl. B29C 65/00; B32B 37/00; B65H 29/00; B32B 31/00

(52) U.S. Cl. 156/538; 156/556; 156/60

(57) ABSTRACT

An apparatus and a method of attaching optical films are provided. The apparatus for attaching optical films comprises a substrate conveyer, an optical film adsorber, an attaching device and a stop element. The substrate conveyer carries and conveys a substrate. The optical film adsorber carries an optical film and orients the optical film towards the substrate conveyer. The attaching device is disposed on the conveying path of the substrate for attaching the optical film to the substrate. The stop element is disposed between the optical film adsorber and the attaching device to stop the edges of the rolling film from attaching to the substrate ahead of time and create bubbles.

### CROSS-REFERENCE TO RELATED APPLICATION

This application claims the priority benefit of Taiwan application serial no. 93121098, filed Jul. 15, 2004.

### BACKGROUND OF THE INVENTION

1. Field of the Invention

The present invention relates to an apparatus and method of attaching optical films. More particularly, the present invention relates to a polarizer attaching device and method that can prevent or reduce the formation of bubbles.

2. Description of the Related Art

The rapid proliferation of multimedia system comes about as a result of the progress in the manufacturing of semiconductor devices and monitors. In the past, the cathode ray tubes (CRT) are the principal display devices in the market because of its superb display quality and moderate pricing. However, due to the bulkiness of CRT and the environmental concerns such as the production of hazardous radiation and consumption of too much power, CRT has been gradually phased out and replaced by more environ-friendly display devices with a compact, slim and light body. One such display device is the liquid crystal display (LCD). Because of the high display quality, superior spatial utilization, low power consumption and radiation free operation, LCD has become one of the mainstream products in the market.

A conventional thin film transistor liquid crystal display (TFT-LCD) typically comprises a thin film transistor (TFT) array, a color filter, a liquid crystal layer between the TFT array and the color filer and at least a polarizer attached to the TFT array and/or the color filter. The method of attaching a polarizer to a substrate includes stationing the substrate on a fixed location and attaching a sheet of polarizer onto the transparent substrate manually. Consequently, the conventional polarizer attachment method is slow and prone to have human attachment errors. In other words, the attachment quality of the polarizer is poor and the production yield is low.

At present, the process of attaching polarizers to substrates is mechanized to produce effective and accurately attached polarizers. However, the process of lifting off the protective film covering the polarizer or any residual stress in the multi-layered polarizer due to cutting often leads to a slight warping of the polarizer close to the edges. With a warped polarizer, the edges of the polarizer are often attached to the substrate before other areas in the process of attachment so that bubbles are trapped inside the finished products.

One effective measure to avoid the problems caused by a warped polarizer is to set up an inspection criterion and sort out the ones that do not meet the standard. Alternatively, the machines carrying out the polarizer attachment can be adjusted to provide some compensation. However, even the maximum range of adjustment is effective only for those that falls within the standard specification. In fact, machine adjustments simply cannot cater for the warping inside the polarizer due to stress arising from other physical phenomena.

### SUMMARY OF THE INVENTION

The present invention is directed to provide an optical film attaching apparatus capable of preventing the edges of an optical film from attaching to a substrate ahead of time, such that fewer bubbles are generated.

The present invention is directed to provide a method of attaching optical films capable of delaying the warped edges of an optical film attaching to a substrate so that fewer bubbles are trapped.

The present invention is directed to provide a method of attaching optical films to a substrate such that fewer bubbles are trapped between the optical film and the substrate. In addition, bubbles preferentially trapped in one area due to a front adsorption failure resulting from material thickness variation or difference in material properties occur less frequently.

As embodied and broadly described herein, the invention provides an optical film attaching apparatus. The optical film attaching apparatus comprises a substrate conveyer, an optical film adsorber, an attaching device and a stop element. The substrate conveyer has a carrying surface for carrying and conveying a substrate. The optical film adsorber carries an optical film and has an adsorbing surface facing the substrate conveyer. The attaching device is disposed on the conveying path of the substrate for attaching the optical film to the substrate. The stop element is disposed between the carrying surface of the substrate conveyer and the adsorbing surface of the optical film adsorber and between the optical film adsorber and the attaching device to stop the edges of the optical film from attaching to the substrate ahead of time.

The present invention further provides a method of attaching optical films. The method comprises transporting substrates using a substrate conveyer and carrying optical films on an optical film adsorber. Thereafter, using an attaching device disposed on the conveying path of the substrates, the optical film is attached to the substrate following the direction of conveyance of the substrate. A stop element is disposed between the optical film adsorber and the attaching device to stop the edges of the optical film from attaching to the substrate ahead of time.

In the present invention, a stop element (similar to an idler) is disposed on the adsorbing element on each side of the optical film adsorber. When the edges of the optical film warp up, the stop element is able to delay the warped section on each side of the optical film from attaching to the substrate ahead of time. Ultimately, the number of bubbles trapped between the optical film and the substrate is minimized.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C are schematic cross-sectional views showing consecutive snapshot of an operating optical film attaching apparatus in the process of attaching an optical film on a substrate according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

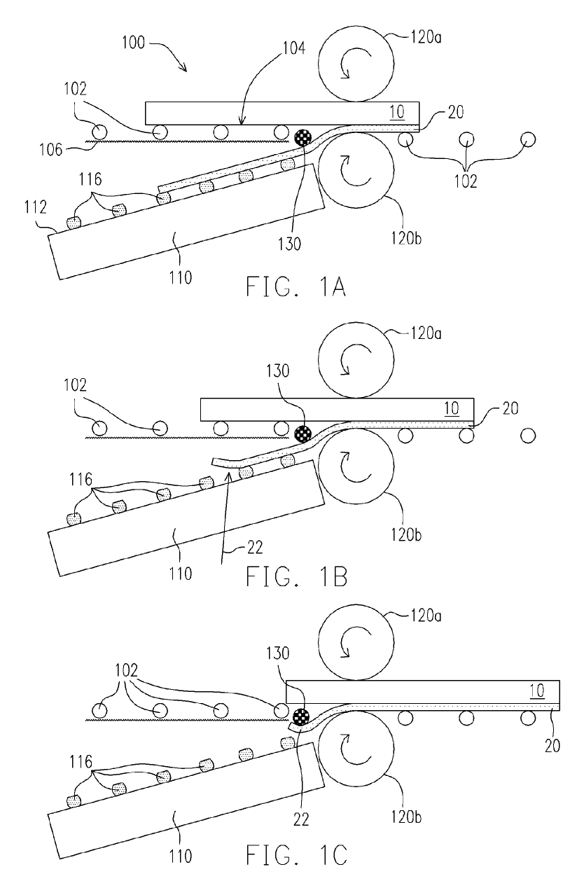

FIGS. 1A through 1C are schematic cross-sectional views showing consecutive snapshot of an operating optical film attaching apparatus in the process of attaching an optical film on a substrate according to one preferred embodiment of the present invention. As shown in FIG. 1A, the optical film attaching apparatus 100 comprises a substrate conveyer 102, an optical film adsorber 110, an attaching device 120a and 120b and a stop element 130. The optical film attaching apparatus 100 is a polarizer attaching device or a device for attaching other types of optical films, for example. The substrate conveyer 102 has a carrying surface 104 for carrying and transporting substrates 10. The optical film adsorber 110 carries an optical film 20 and is a polarizer or other types of optical films, for example. Furthermore, the optical film adsorber 110 has an adsorbing surface 112 facing the substrate conveyer 102. The optical film adsorber 110 may further comprise a plurality of adsorption elements 116 disposed on the adsorbing surface 112. The attaching device 120a and 120b is disposed along the conveying path of the substrates 10 so that the optical film 20 can be attached to the substrate 10. The attaching device 120a and 120b is a group of driving rollers specially designed for attaching optical films. The stop element 130 is disposed between the carrying surface 104 and the adsorbing surface 112 and between the optical film adsorber 110 and the attaching device 120a and 120b to stop the edges of the optical film 20 from attaching to the substrate 10 ahead of time.

In the present embodiment, the stop element 130 can have a plurality of different configurations. For example, the stop element 130 may comprise a plurality of idlers. If the stop element 130 includes only a single idler, the edges of the optical film 20 can be balanced so that the edges of the optical film 20 is prevented from attaching to the substrate 10 ahead of time. When two or more idlers are used in the stop element 130, the idlers can be disposed along the edges of the optical film to reduce contact with the optical film 20 and prevent the attachment of optical film edges to the substrate 10 ahead of time. The stop element 130 can be fabricated using, for example, steel or other suitable materials. Furthermore, the surface of the stop element 130 is preferably fabricated using a non-sticky material because a protective film (not shown) is normally formed over the optical film 20. The protective film has to be removed to expose an underlying plastic layer before attaching to the substrate 10. To prevent the plastic layer on the optical film 20 from adhering to the stop element 130, a detaching film or some other material is disposed on the surface of the stop element 130.

The substrate conveyer 102 in the present invention is a roller conveyer or other types of conveyers such as a chain conveyer, for example. In addition, a dust-proof cover 106 may also be disposed between the optical film adsorber 110 and the substrate conveyer 102 to prevent particles from depositing on the optical film 20 underneath the substrate conveyer 102 and affecting subsequent display quality of the optical film. Furthermore, the adsorbing element 116 can be an adsorption pad for adsorbing the optical film 20 but also permits the optical film 20 to move along with the attaching device 120a and 120b. Because the optical film 20 adheres to the adsorbing elements 116 in the first part of the process for attaching the optical film 20 to the substrate 10 through the attaching device 120a and 120b, warped sections of the optical film 20 are not attached to the substrate 10.

As shown in FIG. 1B, the edge of the optical film 20 detaches from the adsorbing elements 116 of the optical film adsorber 110. Meanwhile, peeling the protective layer (not shown) from the optical film produces a warping edge 22 in the optical film 20.

The warped edge 22 of the optical film 20 will attach to the substrate 10 ahead of time to trap bubbles between the substrate 10 and the optical film 20 if no stop element is set up to restrain the edge 22 already detached from the adsorbing elements 116. As shown in FIG. 1C, a stop element 130 is set up in the present invention to prevent an early attachment of the warped edge 22 of the optical film 20 to the substrate 10 thereby reducing the quantity of trapped bubbles.

In summary, one major aspect of the present invention is the disposition of a stop element between the optical film adsorber and the attaching device. When the edges of the optical film warp up, the stop element is able to prevent the warped section on each side of the optical film from attaching to the substrate ahead of time. Ultimately, the quantity of bubbles trapped between the optical film and the substrate is minimized. Furthermore, aside from attaching polarizers, the film attaching apparatus of the present invention can also be used to attach other kinds of optical films.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical film attaching apparatus for attaching an optical film onto a substrate, the apparatus comprising:
a substrate conveyer for carrying and transporting substrates;
an optical film adsorber facing the substrate conveyer for carrying optical films;
an attaching device disposed along a conveying path of the substrates for attaching the optical film to the substrate; and
a stop element disposed between the optical film adsorber and the attaching device to prevent an edge of the optical film from attaching to the substrate ahead of time.

2. The optical film attaching apparatus of claim 1, wherein the substrate conveyer has a carrying surface, the optical film adsorber has an adsorbing surface such that the adsorbing surface faces the substrate conveyer, and the stop element is disposed between the carrying surface of the substrate conveyer and the adsorbing surface of the optical film adsorber.

3. The optical film attaching apparatus of claim 1, wherein the stop element comprises an idler disposed in parallel to the edges of the optical film.

4. The optical film attaching apparatus of claim 1, wherein the stop element comprises a plurality of idlers arranged in parallel to the edges of the optical film.

5. The optical film attaching apparatus of claim 1, wherein the stop element is fabricated using steel.

6. The optical film attaching apparatus of claim 1, wherein the optical film comprises a polarizer.

7. The optical film attaching apparatus of claim 6, further comprising a detaching film disposed on a surface of the stop element to prevent adhesion with a plastic layer on the polarizer.

8. The optical film attaching apparatus of claim 1, wherein the substrate conveyer comprises a roller type conveyer.

9. The optical film attaching apparatus of claim 1, further comprising a dust-proof cover disposed between the optical film adsorber and the substrate conveyer.

10. The optical film attaching apparatus of claim 1, wherein the attaching device comprises a group of driving rollers.

11. A method of attaching optical films, comprising the steps of:
transporting a substrate using a substrate conveyer;
carrying an optical film using an optical film adsorber;
attaching the optical film to the substrate in a substrate conveying direction using an attaching device set up along the substrate conveying pathway; and
disposing a stop element between the optical film adsorber and the attaching device to prevent an edge of the optical film from attaching to the substrate ahead of time.

12. The method of claim 11, wherein the substrate conveyer has a carrying surface and the optical film adsorber has an adsorbing surface such that the stop element is disposed between the carrying surface and the adsorbing surface.

13. The method of claim 11, wherein the stop element comprises an idler disposed in parallel to the edges of the optical film.

14. The method of claim 11, wherein the stop element comprises a plurality of idlers arranged in parallel to the edges of the optical film.

15. The method of claim 11, wherein the stop element is fabricated using steel.

16. The method of claim 11, wherein the optical film comprise a polarizer.

17. The method of claim 16, wherein a detaching film is disposed on a surface of the stop element to prevent adhesion with a plastic layer on the polarizer.

18. The method of claim 11, wherein the substrate conveyer comprises a roller type conveyer.

19. The method of claim 11, wherein a dust-proof cover is disposed between the optical film adsorber and the substrate conveyer.

20. The method of claim 11, wherein the attaching device comprises a group of driving rollers.
